(19) United States
(12) Patent Application Publication
(10) Pub. No.: US 2006/0121154 A1
(43) Pub. Date: Jun. 8, 2006

(54) Laser device for alignment of a nozzle tip within injection molding and extrusion equipment

(76) Inventor: Duane Manning, North Ogden, UT (US)

Correspondence Address: THORPE NORTH & WESTERN, LLP., 8180 SOUTH 700 EAST, SUITE 200, SANDY, UT, 84070, US

(21) Appl. No.: 11/239,975

(22) Filed: Sep. 30, 2005

Related U.S. Application Data
(60) Provisional application No. 60/615,181, filed on Sep. 30, 2004.

(51) Int. Cl. B29C 45/22

(52) U.S. Cl. 425/564

(57) ABSTRACT

The present invention provides a method and device that uses an injection nozzle for use in injection molding processes, wherein an insert laser cartridge is configured to slide inside the nozzle. Light from the laser emits through the nozzle onto a target thereby giving an accurate alignment point. After the alignment is established the insert cartridge can be taken out to allow for normal use of the injection nozzle. The present invention also provides a method and device for aligning the extrusion die of an extrusion device with the conveyor structure.

This application claims priority to U.S. Provisional Application Ser. No. 60/615,181, filed Sep. 30, 2004, and entitled, “Laser Device for Alignment of a Nozzle Tip Within Injection Molding Equipment,” which is incorporated by reference herein in its entirety.

### BACKGROUND OF THE INVENTION

1. Field of the Invention

The present invention relates generally to a nozzle for an injection molding or polymer extrusion unit. More particularly, the present invention relates to a device and method to align an injection nozzle or an extrusion port using a laser.

2. Related Art

The fabrication of plastic parts may be accomplished by many forms of molding techniques. Two prominent methods of forming plastic products are injection and extrusion processes. FIG. 1 shows a basic configuration for an injection molding system. Typically, the process uses pellets that feed from a hopper 1 into the rear end of a heating cylinder 2. A plunger 3 pushes the plastic forward into a space between walls of the cylinder and a heated torpedo 4 in the middle of the cylinder. Melted plastic arrives at an injection nozzle 5, where it is transferred to a mold body 6. FIG. 2 illustrates a conventional extrusion device. It is similar in operation, except that the melted plastic is conveyed by a screw 7 to an extrusion die 8, which then forms the melted plastic to a uniform cross section that is received on a conveyor system 9.

In injection molding systems, maintenance often requires service procedures that result in misalignment of the injection apparatus, and in particular the nozzle 5. As a consequence, realignment of the injection apparatus must be made between the spru bushing 10 of the mold and the injection nozzle. In general, this is done by making manual adjustments with respect to the nozzle based on subjective assessments of the degree of misalignment. After each successive adjustment, the operator visually checks for the required perfect alignment. This process typically requires multiple adjustments and can become very time consuming. Mold downtime may be very costly. Similarly, extrusion equipment requires proper alignment of the conveyor system with the output axis of the extrusion die to ensure that the molded plastic cross section is not compromised in being transferred from the die to the conveyor.

### SUMMARY OF THE INVENTION

It is therefore recognized that it would be advantageous to develop a convenient way for aligning an injection nozzle with a mold or an extrusion die with the conveyor.

The present invention provides an injection nozzle for use in injection molding processes wherein an insert laser cartridge is configured to slide inside the nozzle. Light from the laser is then emitted through the nozzle onto a target, thereby giving an accurate alignment point. After the alignment is established, the cartridge can be taken out to allow for normal use of the injection nozzle. Similarly, an alignment laser can be inserted within the conduit of the die in an extrusion system, and positioning of the conveyor can be readily accomplished with respect to a projected laser beam propagated along a longitudinal axis of the die.

In accordance with a more detailed aspect of the present invention, the system may include a stop member to secure the laser cartridge within the nozzle for greater accuracy in the alignment process.

The present invention also provides a separate nozzle tool for injection nozzle alignment. This tool comprises a housing that is shaped like the injection nozzle and contains a laser light-emitting device inside. The tool is placed on the injection molding machine in the normal position of the injection nozzle to allow the alignment process to take place. Then the tool is removed so an actual nozzle may be attached in an already aligned state.

The present invention also provides a method for aligning injection molding nozzles. This method comprises the steps of placing a laser cartridge within an injection molding nozzle, using emitted laser light from within the nozzle for alignment of the nozzle with a mold, and removing the laser cartridge after the alignment for ordinary use of the injection nozzle.

The present invention also provides an alternative method for aligning injection mold nozzles. This method comprises the steps of placing an injection nozzle-shaped tool containing a laser device onto an injection molding machine, aligning the nozzle-shaped tool and a mold with light emitted from the laser device, removing the tool, and placing a functional nozzle onto the injection mold machine for normal use.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 illustrates a prior art representation of an injection molding system.

FIG. 2 depicts a prior art representation of an extrusion process and device.

FIG. 3 shows a perspective view of an injection nozzle and a laser cartridge in accordance with an embodiment of the present invention;

FIG. 4 is a cross-sectional view of the injection nozzle with the laser cartridge inserted;

FIG. 5 is a cross-sectional view of the injection nozzle with the laser cartridge inserted along with a stop member in accordance with another embodiment of the present invention;

FIG. 6 illustrates an injection nozzle alignment tool in accordance with another embodiment of the present invention;

FIG. 7 is a flow diagram of a method embodiment of the present invention; and

FIG. 8 is a flow diagram of an alternative method embodiment of the present nozzle alignment invention.

FIG. 9 is a cross-sectional view of the extrusion die having a laser alignment device journaled within the die opening and aligned with a conveyor device.

FIG. 10 is a flow diagram of a method embodiment of the present extrusion alignment invention.

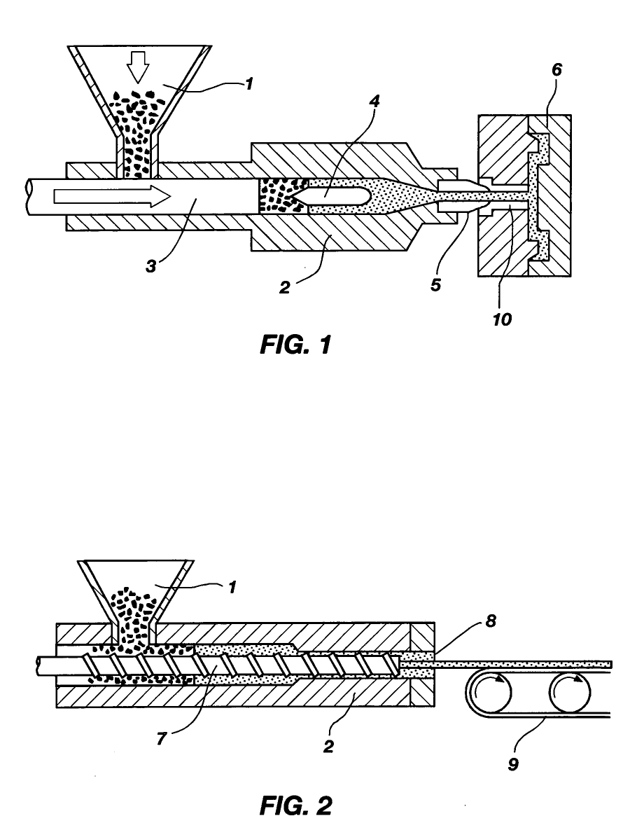

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

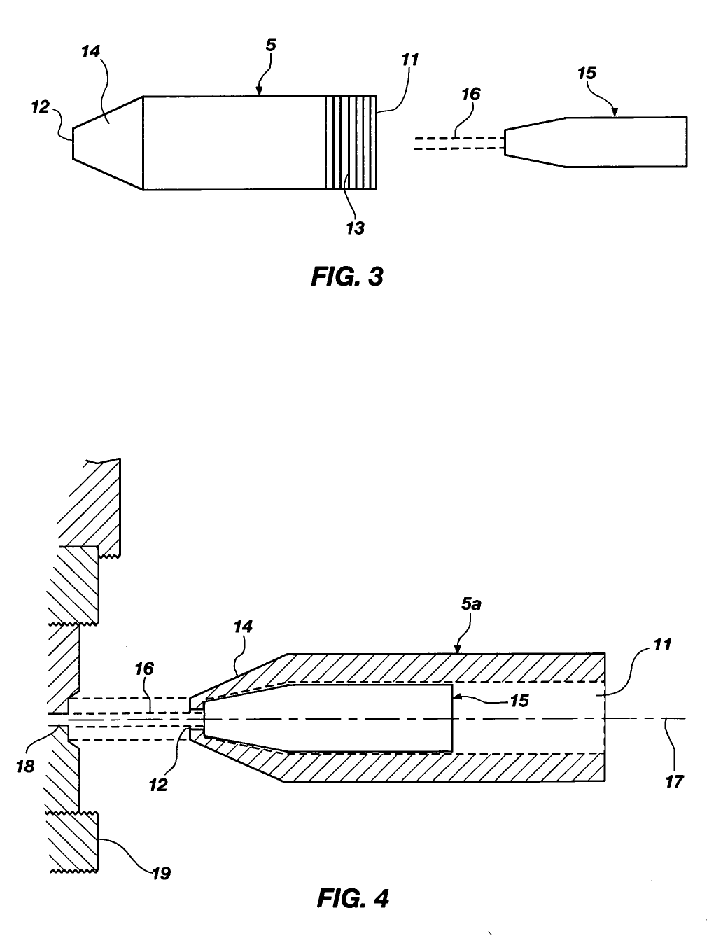

As illustrated in FIGS. 3 and 4, an injection nozzle 5 for use in an injection molding process which has first 11 and second 12 axial ends that define holes through which the injected material flows. Inherent in a nozzle and as illustrated, the hole in the first end 11 is larger in diameter than the hole in the second end 12 to accommodate injection procedures. In this case the nozzle is threaded on its outer surface 13 for removal from the injection system. It should be noted that this removal may be implemented a number of ways according to different injection molding systems known to one skilled in the relevant art. A special radius at the end 14 is common in this field and is done to allow for a good fit and seal of the injection nozzle with the spru bushing of the mold during the injection process.

An insert laser cartridge 15 is configured to align an emitted laser beam 16 along a common central axis 17 with the nozzle. This cartridge slides into the hole of the first axial end 11 and fits snuggly within the interior space of the nozzle 5. The laser cartridge 15, in this case, is encasing a simple semiconductor laser, but the laser could be implemented in any number of ways known in the field. The cartridge 15 can be any shape that fits well inside the nozzle 5 to prevent unwanted movement and to allow emitted laser light 16 to proceed through the hole in the second axial end 12 and along the common central axis 17. The emitted light 16 places an accurate target point 18 on the spru bushing of the mold 19 that denotes exactly where the injection nozzle is aligned, thereby allowing for accurate alignment of the nozzle 5 with a specified placement on the mold 19.

Instead of using an actual nozzle 5, the laser cartridge can be carried by a nozzle shaped carrier 5a having common dimensions with the nozzle. This avoids damage or inappropriate use of an otherwise valuable component of the injection molding system for alignment purposes. FIG. 4 illustrates the use of such a carrier.

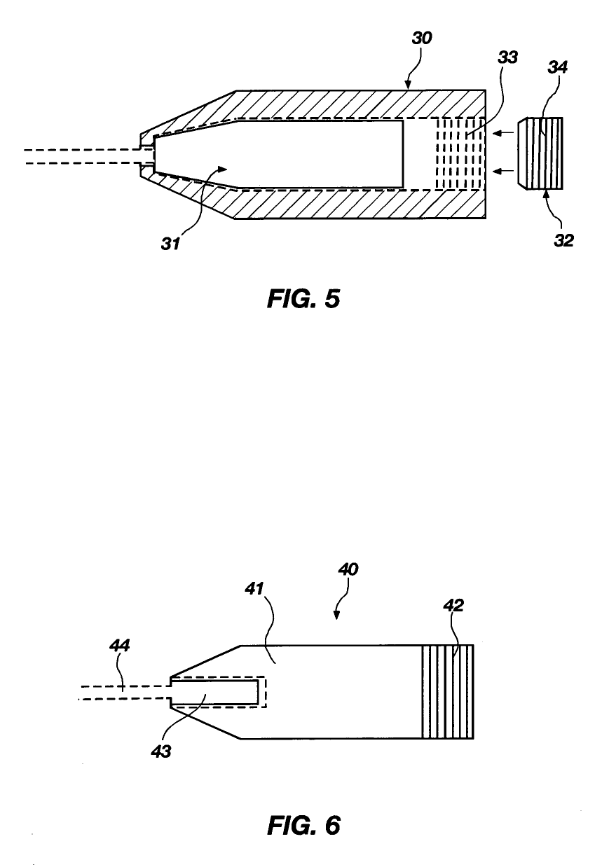

FIG. 5 illustrates an alternate embodiment of this invention wherein the laser cartridge 31 is secured within the injection nozzle 30. A stop member 32 is employed to secure the laser cartridge 31, thereby preventing unwanted movement within the injection nozzle 30. In this embodiment the first axial end of the nozzle has interior threading 33. The stop member 32 is also threaded 34 to allow for insertion and removal. It should be noted that the stop member could be implemented by any means that presses the laser cartridge into a secure placement, as long as the stop member allows the nozzle to be placed on the injection machine without encumbrance. An alternate example of a stop member could be a rubber plug or a cork device.

FIG. 6. illustrates an injection nozzle alignment tool 40 in accordance to another embodiment of the present invention. An injection nozzle-shaped housing 41 is configured to the same shape as an actual nozzle to be removably attached within a nozzle housing of an injection molding machine. In the figure shown, this attachment is implemented with external threading shown by 42. As in previous examples, this attachment may be implemented a number of ways according to different injection molding systems known to one skilled in the relevant art.

A laser device 43 is embedded within the housing 41 to emit a light 44 onto a target or the mold spru that represents a nozzle alignment point. This laser device may also be implemented in any manner that would allow for a coherent light point on the target. When alignment is achieved, the tool may be removed and replaced by a working injection nozzle.

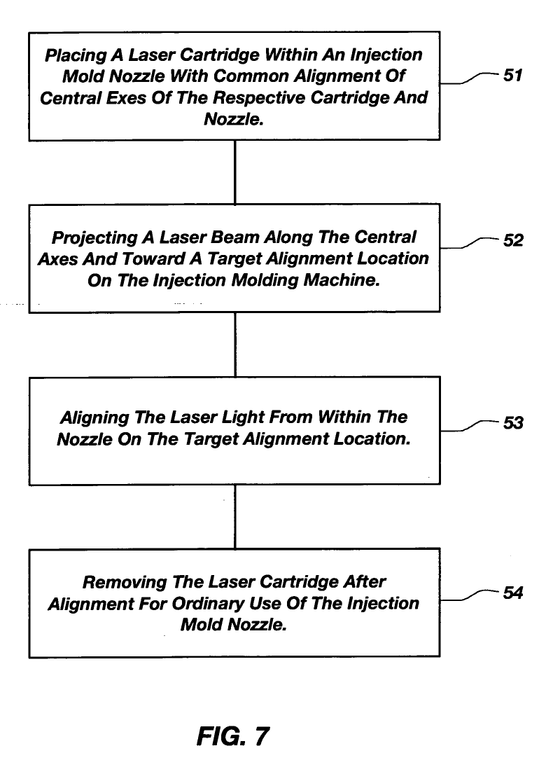

FIG. 7 shows a possible flow diagram of a method for aligning injection mold nozzles. This method includes the steps of placing a laser cartridge within an injection mold nozzle 51 with common alignment of central axes of the respective cartridge and nozzle, emitting a laser beam 52 along a central axis of the cartridge, using axially emitted laser light from within the nozzle for alignment 53 of the nozzle with a mold, and removing the laser cartridge 54 after alignment for ordinary use of the injection mold nozzle.

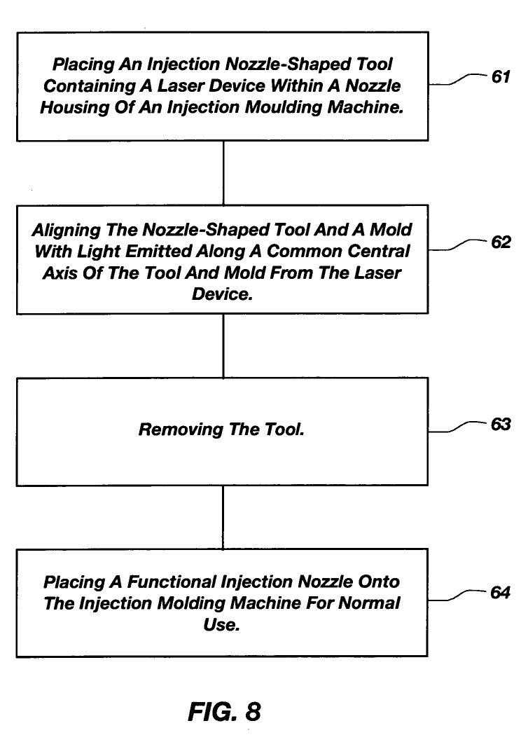

FIG. 8 shows a possible flow diagram of a method for aligning injection mold nozzles, utilizing a nozzle-shaped carrier in place of the actual injection nozzle. This method includes the steps of placing an injection nozzle-shaped tool containing a laser device within a nozzle housing of an injection molding machine 61, aligning the nozzle-shaped tool and a mold spru with light emitted along a common central axis of the injection nozzle and mold spru from the laser device 62, removing the tool 63, and placing a functional injection nozzle onto the injection mold machine for normal use 64.

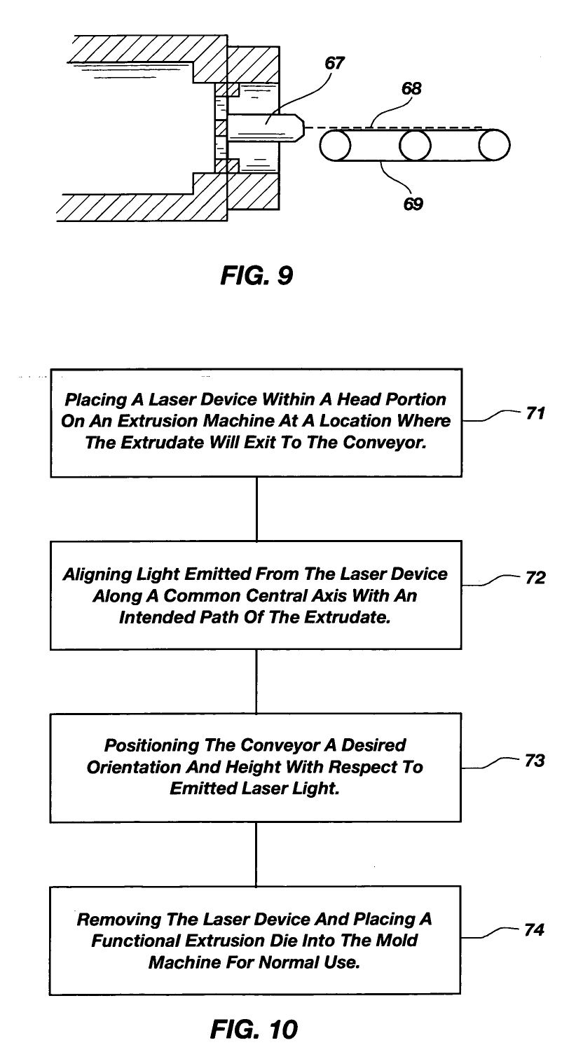

FIG. 9 illustrates application of this alignment technique to an extrusion system. In this case, the alignment laser is positioned at the position of the die opening so as to project a laser beam along the intended path of the extrudate. This can be accomplished by attaching the laser to spider structure positioned within the extrusion head at an exit end of the cylinder as shown in the figure. The laser can then be operated and aligned with the intended path of the extruded plastic or extrudate. The conveyor structure can then be moved to a proper height and orientation to receive the extrudate as it exits the die opening during an actual extrusion operation.

FIG. 10 shows a possible flow diagram of a method for aligning an extrusion die with the conveyor portion, utilizing a laser alignment cartridge mounted at the extrusion head or die opening. This method includes the steps of placing a laser 71 device within head of an extrusion machine at a location where the extrudate will exit to the conveyor, aligning the light 72 emitted along a common central axis with the path of the extrudate, positioning the conveyor 73 a desired orientation and height with respect to emitted laser light, removing the laser device 74, and placing a functional extrusion die into the mold machine for normal use.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

1. A nozzle for alignment of injection molding equipment, comprising:
a) a carrier nozzle shaped like an injection nozzle for use in an injection molding process; and
b) an insert laser cartridge positioned within the carrier nozzle for emitting a laser beam aligned along a central axis of the carrier nozzle.

2. The nozzle of claim 1, wherein the nozzle includes an interior space having first and second axial ends such that the first and second ends define holes, wherein the hole in the first end is larger in diameter than the hole in the second end, allowing emitted laser light to proceed through the hole in the second axial end, thereby allowing for accurate alignment of the nozzle with a specified placement on the mold.

3. The nozzle of claim 2, wherein the first end of the nozzle has an inner thread to allow a threaded stop member to be secured

4. The nozzle of claim 2, further comprising a stop member removably configured within the first end, wherein the stop member tightly secures the laser cartridge within the interior space.

5. The nozzle of claim 1, wherein the nozzle comprises an actual nozzle useful as part of an injection molding device.

6. A method for aligning injection mold nozzles within an injection molding machine, comprising:
a) placing a laser cartridge within an injection mold nozzle carrier device with common alignment of central axes of the respective cartridge and nozzle;
b) projecting a laser beam along the central axes and toward a target alignment location on the injection molding machine;
c) aligning the laser light from within the nozzle on the target alignment location; and
d) removing the laser cartridge after alignment.

7. A method as in claim 6, further comprising inserting a stop member against the laser cartridge within the nozzle to secure the cartridge in an alignment position.

8. A method for aligning an extrusion die with a carrier for the ejected extrudate, comprising:
a. placing a laser device within a head portion of an extrusion machine at a location where the extrudate will exit to the conveyor,
b. aligning light emitted from the laser device along a common central axis with an intended path of the extrudate,
c. positioning the conveyor a desired orientation and height with respect to emitted laser light, and
removing the laser device and placing a functional extrusion die into the mold machine for normal use.
